(19) United States
(12) Patent Application Publication
(10) Pub. No.: US 2007/0108033 A1
(43) Pub. Date: May 17, 2007

(54) SLENDER KEYSWITCH STRUCTURE

(76) Inventor: WEI-PONG LIN, Kweishan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/557,722

(22) Filed: Nov. 8, 2006

(30) Foreign Application Priority Data
Nov. 11, 2005 (TW) 094139744

(51) Int. Cl. H01H 13/14

(52) U.S. Cl. 200/520

(57) ABSTRACT

The invention is to provide a keyswitch disposed on an electronic apparatus. According to the invention, the keyswitch includes a keycap, a resilient member and a switch. When an external force acts on a press portion of the keycap, the keycap compresses the resilient member such that a plurality of resilient ends of the resilient member slide on the keycap, and that a projection, formed on an inner surface of the press portion, is actuated by the keycap to turn on the switch.

### BACKGROUND OF THE INVENTION

1. Field of the Invention

The present invention relates to a keyswitch structure, and more particularly, to a slender keyswitch structure applied to a mobile electronic apparatus which is slim and slight.

2. Description of the Prior Art

Generally speaking, keyswitches are sited on an electronic apparatus, and more particularly, on a mobile electronic apparatus, so as to facilitate users in the manipulation of these electronic apparatus.

For instance, a shutter keyswitch sited on a camera is a necessary keyswitch and is the most important user interface when users take photographs. Therefore, one of the most critical requirements in selecting a camera is whether the shutter keyswitch is easy to be manipulated and whether the quality of the photograph is affected by the shutter keyswitch when it is manipulated. In accordance with the requirements above, the shutter keyswitches applied to cameras are generally made in simple designs, such as circular or fat shape.

With respect to the shutter of the camera of the prior art, a compressed spring is sited under a circular or a fat keycap. The compressed spring supports the keycap to create the sense of taction when users press the shutter keyswitch. In the prior art, the spring is sited under the center of the keycap, and a constant preload is provided when the keyswitch is assembled. After the assembly of the camera is finished, the spring given a preload is capable of supporting the shutter keyswitch, and it provides users with the sense of taction when users press the shutter. During the process of each press, the compressed spring can evenly acts on the circumference of the circular or fat keycap, effectively cooperate with the switch of the keyswitch and recoil back to its original state.

Since the shutter keyswitch in prior art is actuated by a compress spring cooperating with a circular or fat keycap, the upward force produced by the compressed spring has to evenly act on the circumference of the circular or fat keycap to effectively support the keycap; this cooperation can avoid the circumstances that the shutter keyswitch slants from the center position or that the sense of taction in manipulation is not good. On the other hand, at present, the design of electronic apparatus is preferred to be slim and slight. This design easily creates a problem of inadequate inner space. In order to facilitate manipulation, the traditional circular or fate keycap has to be transformed into a slender one which occupies less space and increases the surface area for manipulation. However, if the slender keycap of the shutter keyswitch cooperates with traditional compressed spring structure, many undesirable circumstances may occur, resulting in the shutter keyswitch not being able to work smoothly or even failing to work. These circumstances include the keycap not being able to actuate the inner switch, users having bad sense of taction in manipulation, and the keycap contacting the switch abnormally . . . , and so forth.

Accordingly, a scope of the invention is to provide a keyswitch structure, so as to solve the problem mentioned above.

### SUMMARY OF THE INVENTION

A scope of the invention is to provide a keyswitch structure and, more particularly, a slender keyswitch structure especially applied to a mobile electronic apparatus which is slim and slight.

According to a preferred embodiment of the present invention, a keyswitch structure is disposed on an electronic apparatus. The electronic apparatus includes a casing having an outer wall and an inner wall opposite to the outer wall. A through hole is formed on the outer wall. Besides, the keyswitch structure also includes a keycap, a resilient member, and a switch. Moreover, the keycap includes a press portion and an engagement portion. The engagement portion protrudes from a circumference of the press portion and is movably limited by the outer wall. The press portion includes a projection formed on an inner surface thereof. The keycap is substantially disposed in the hole of the outer wall such that the press portion is partially exposed outside the hole. The resilient member includes at least one fixed portion and a plurality of resilient ends. All of the at least one fixed portions is fixed on the inner wall. Besides, the resilient ends of the resilient member abuts against the keycap and supports the keycap to vertically move along the inner wall. Finally, the switch is disposed on the inner wall, too. When an external force acts on the press portion of the keycap, the keycap compresses the resilient member such that the resilient ends of the resilient member slide on the keycap, and that the projection is actuated by the keycap to turn on the switch.

The advantage and spirit of the invention may be further understood by the following recitations together with the appended drawings.

### BRIEF DESCRIPTION OF THE APPENDED DRAWINGS

FIG. 1A is a vertical view illustrating the keyswitch structure 12 according to a preferred embodiment of the invention.

FIG. 1B is a cross-sectional view illustrating the keyswitch structure 12 in FIG. 1A along the A-A line.

FIG. 1C is a cross-sectional view illustrating the keyswitch structure 12 in FIG. 1B along the B-B line.

FIG. 2 is an upward view illustrating the keyswitch structure 12 according to the invention.

FIG. 3A is a schematic diagram, in accordance with the invention, illustrating the state that the keyswitch structure 12 is not under an external force.

FIG. 3B is a schematic diagram, in accordance with the invention, illustrating the state that the center of the slender keycap 16 of the keyswitch structure 12 is not under an external force pressed against it.

FIG. 3C is a schematic diagram, in accordance with the invention, illustrating the state that the right side of the slender keycap 16 of the keyswitch structure 12 is not under an external force pressed against it.

### DETAILED DESCRIPTION OF THE INVENTION

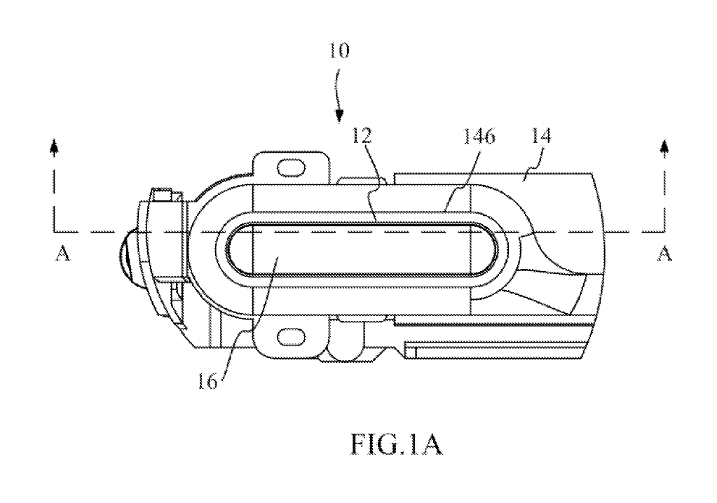

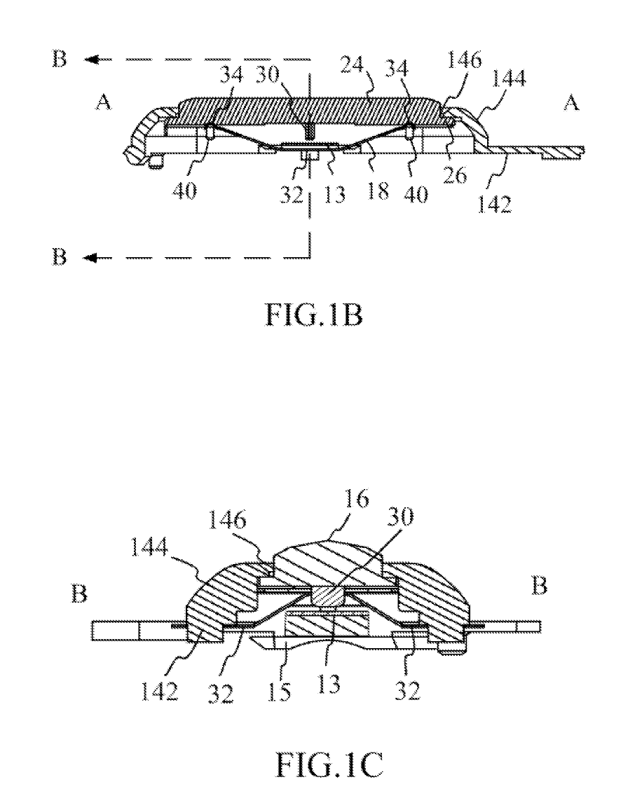

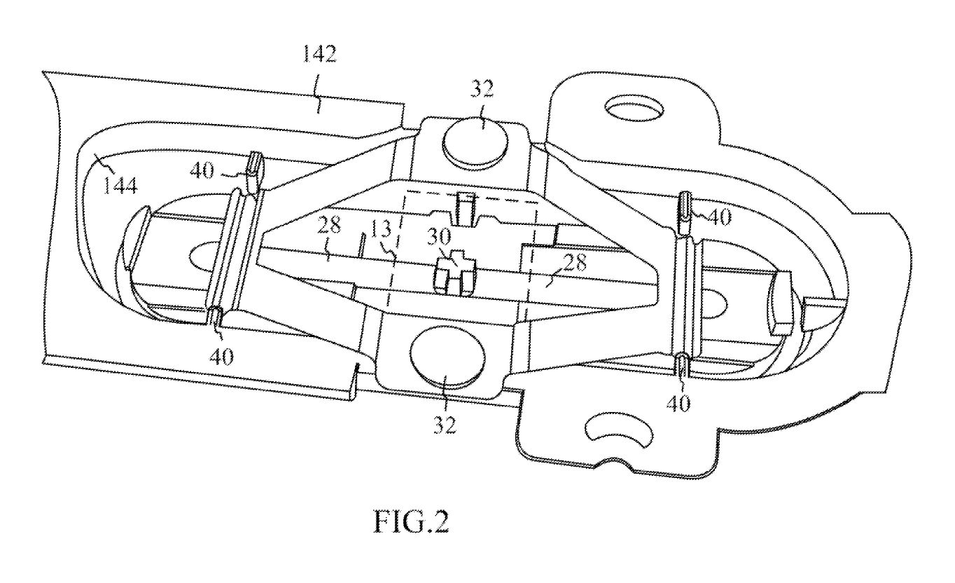

Referring to FIG. 1A to 1C and FIG. 2, a keyswitch structure 12 according to a preferred embodiment of the invention is shown in these figures.

FIG. 1A is a vertical view illustrating the keyswitch structure 12 according to the preferred embodiment of the invention; it also illustrates a part of the casing of an electronic apparatus 10 installed with the keyswitch structure 12. The casing has an outer wall 14 and an inner wall 15, which is illustrated in FIG. 1C, opposite to the outer wall. Besides, a through hole 146 is formed on the outer wall 14. In an embodiment, the electronic apparatus 10 is a mobile electronic apparatus, such as a camera.

FIG. 1B is a cross-sectional view illustrating the keyswitch structure 12 in FIG. 1A along the A-A line. FIG. 1C is a cross-sectional view illustrating the keyswitch structure 12 in FIG. 1B along the B-B line. FIG. 2 is an upward view illustrating the keyswitch structure 12. As shown in FIG. 1A, FIG. 1B, FIG. 1C and FIG. 2, the keyswitch structure 12 includes a keycap 16, a resilient member 18 and a switch 13.

As show in FIG. 1B, FIG. 1C, and FIG. 2, the outer wall 14 includes a base portion 142 and a protrusion portion 144, whereon the through hole 146 is formed. The protrusion portion 144 outwardly protrudes from the base portion 142 to the outside of the electronic apparatus 10, forming an accommodating space. Besides, the keycap 16 is sited in the accommodating space of the outer wall 14.

As shown in FIG. 1B, FIG. 1C, and FIG. 2, the keycap 16 includes a press portion 24 and an engagement portion 26 protruding from a circumference of the press portion 24. The keycap 16 is substantially disposed in the through hole 146 of the outer wall such that the press portion 24 is partially exposed outside the through hole 146, and that the engagement portion 26 is movably limited by the outer wall 14. Furthermore, a projection 30 is sited on an inner surface of the press portion 24.

In an embodiment, the keycap 16 is a slender keycap.

As shown in FIG. 1B, FIG. 1C and FIG. 2, the resilient member 18 includes at least one fixed portion 32 and a plurality of resilient ends 34. All of the at least one fixed portions 32 is fixed on the inner wall 15. The plurality of resilient ends 34 of the resilient member 18 abuts against the keycap 16 and supports the keycap 16 to vertically move along the inner wall 15.

In an embodiment, as shown in FIG. 1B, FIG. 1C and FIG. 2, the engagement portion 26 thereon forms a plurality of guiding grooves 28. Each of the resilient ends 34 of the resilient member 18 is slidablly disposed in one of the guiding grooves 28. Therefore, in the process that the keycap 16 vertically moves along the inner wall 15, the plurality of resilient ends 34 guided by the plurality of grooves 28 slides linearly.

In an embodiment, as shown in FIG. 1B, FIG. 1C and FIG. 2, the plurality of the resilient ends 34 of the resilient member 18 linearly contact the keycap 16 to improve the rigidity of the plurality of the resilient ends 34. Therefore, in the process that the keycap 16 vertically moves along the inner wall 15, the plurality of resilient ends 34 slides with less friction relative to the keycap 16, so as to improve the tactile feeling and smoothness of the keyswitch structure 12 in manipulation.

In an embodiment, the resilient member 18 is made from a thin steel plate.

In an embodiment, as shown in FIG. 1B, FIG. 1C, and FIG. 2, the resilient member 18 also includes a plurality of resilient arms, each of which protrudes from one of the at least one fixed portion 32. Besides, each of the resilient ends 34 is formed on one of the resilient arms.

The switch 13 is disposed on the inner wall 15. When an external force acts on the press portion 24 of the keycap 16, the keycap 16 compresses the resilient member 18 so that the resilient ends 34 of the resilient member 18 slide on the keycap 16, and that the projection 30 is actuated by the keycap 16 to turn on the switch 13.

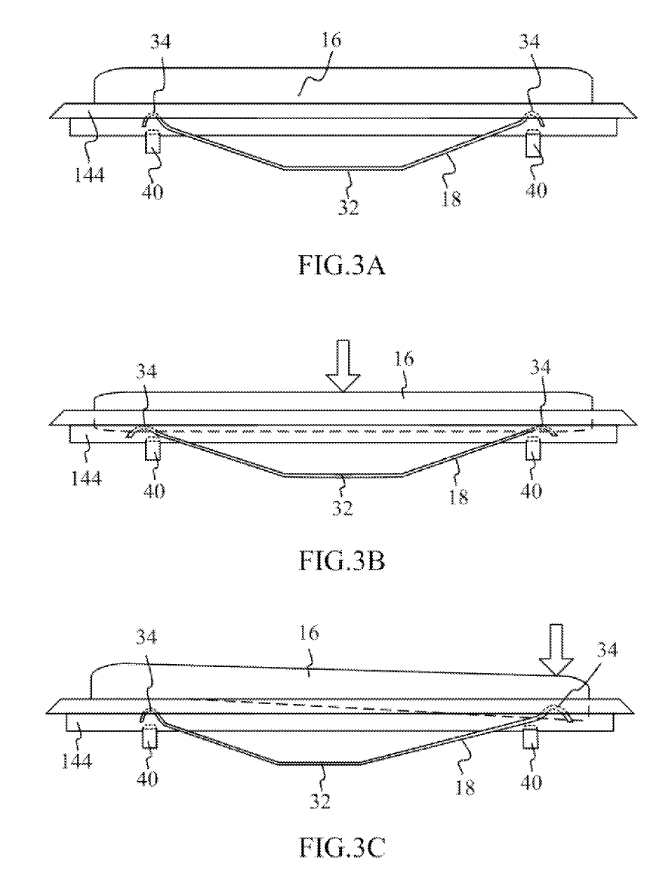

In an embodiment, as shown in FIG. 1B, FIG. 1C and FIG. 2, the casing further includes a plurality of position bosses 40. The plurality of position bosses 40 protrudes from the base 142 of the outer wall 14 toward the accommodating space to block the keycap 16 from sliding out of the accommodating space. In another embodiment, the casing further includes a plurality of position bosses 40. The plurality of position bosses 40 protrudes from the protrusion portion 144 of the outer wall 14 toward the accommodating space to block the keycap 16 from sliding out of the accommodating space by a slanted force, as shown in FIG. 3C.

Referring to FIG. 3A, FIG. 3B and FIG. 3C, according to the invention, these figures illustrate all states of the slender keycap 16 sited on the keyswitch structure 12 whether it is acted upon by an external force or not. FIG. 3A, in accordance with the invention, illustrates the state that the keyswitch structure 12 is not under an external force. As shown in FIG. 3A, the slender keycap 16 is supported by the resilient member 18; the press portion 24 of the slender keycap 16 is partially exposed outside the through hole 146 of the outer wall 14.

According to the invention, FIG. 3B illustrates the state that the slender keycap 16 of the keyswitch structure 12 is receiving an external force, which is marked by an arrow in the figure, against the center of the keycap 16. As shown in FIG. 3B, at this time, the resilient arm of the resilient member 18 connecting with the resilient ends 34 synchronously has downward and even deformation (moving to the horizontal line marked by a dotted line), with the fulcrum at the fixed portion 32 of the resilient member 18. The evenly deformed resilient arms provide a sense of taction for users, and they also provide the kinetic energy which makes the slender keycap 16 recoil back to the original position after the external force is removed. Under these circumstances, the projection 30 sited on the slender keycap 16 is effectively actuated by the keycap 16 to turn on the switch 13.

According to the invention, FIG. 3C illustrates the state that the slender keycap 16 of the keyswitch structure 12 is receiving an external force, which is marked by an arrow in the figure, against the right side of the keycap 16. As shown in FIG. 3C, besides one fulcrum at the fixed portion 32 of the resilient member 18, another fulcrum is formed by the resilient ends 34 which get stuck with the position boss 40. The slender keycap 16 will tilt toward its right side, and the resilient arm of the resilient member 18 on the right will have much more deformation. On the other hand, the resilient arm of the resilient member 18 on the left has almost no deformation. Only the arm on the right provides a sense of taction for users, and it also provides the kinetic energy which makes the slender keycap 16 recoil back to the original position after the external force is removed. Under these circumstances, the projection 30 sited on the slender keycap 16 is effectively actuated by the keycap 16 to turn on the switch 13.

With the recitations regarding the execution of the invention, it clearly shows that the problems expected in the prior art will not easily occur, even if the slender keyswitch in accordance with the invention is pressed at its periphery. These problems include the keycap not being able to actuate the inner switch, users having bad sense of taction in manipulation, users pressing the keyswitch imprudently, and the keycap contacting the switch abnormally . . . , and so forth. Compared with traditional keyswitch cooperating with compressed spring, and circular or fat keycap, the keyswitch structure in accordance with this invention has better reinstatement and more room for shape design.

With the recitations of the preferred embodiment above, the features and spirits of the invention will be hopefully well described, but the scope of the invention will not be constrained. However, the objective is expected to cover all alternative and equivalent arrangements in the scope of the appended claims for which the invention apply.

What is claimed is:

1. A keyswitch disposed on an electronic apparatus, the electronic apparatus comprising a casing, the casing having an outer wall and an inner wall opposite to the outer wall, a through hole being formed on the outer wall, said keyswitch comprising:
a keycap, comprising:
a press portion, comprising a projection formed on an inner surface of the press portion; and
an engagement portion, protruding from a circumference of the press portion and being movably limited by the outer wall;
wherein the keycap is substantially disposed in the through hole of the outer wall such that the press portion is partially exposed outside the through hole;
a resilient member comprising a fixed portion and a plurality of resilient ends, the fixed portion being fixed on the inner wall, the resilient ends of the resilient member abutting against the keycap and supporting the keycap to vertically move along the inner wall; and
a switch, disposed on the inner wall;
wherein when an external force acts on the press portion of the keycap, the keycap compresses the resilient member such that the resilient ends of the resilient member slide on the keycap, and that the projection is actuated by the keycap to turn on the switch.

2. The keyswitch of claim 1, wherein a plurality of guiding grooves are formed on the engagement portion, each of the plurality of resilient ends of the resilient member is slidablly disposed in one of the guiding grooves.

3. The keyswitch of claim 1, wherein the resilient member is formed from a thin steel plate.

4. The keyswitch of claim 1, wherein the keycap exhibits a slender shape.

5. The keyswitch of claim 1, wherein the electronic apparatus is a mobile electronic apparatus.

6. An electronic apparatus, comprising:
a casing, comprising an outer wall and an inner wall opposite to the outer wall, a through hole being formed on the outer wall;
a keyswitch, comprising:
a keycap comprising:
a press portion, comprising a projection formed on an inner surface of the press portion; and
an engagement portion, protruding from a circumference of the press portion and being movably limited by the outer wall;
wherein the keycap is substantially disposed in the through hole of the outer wall such that the press portion is partially exposed outside the through hole;
a resilient member comprising at least one fixed portion and a plurality of resilient ends, the at least one fixed portion being fixed on the inner wall, the resilient ends of the resilient member abutting against the keycap and supporting the keycap to vertically move along the inner wall; and
a switch, disposed on the inner wall;
wherein when an external force acts on the press portion of the keycap, the keycap compresses the resilient member such that the resilient ends of the resilient member slide on the keycap, and that the projection is actuated by the keycap to turn on the switch.

7. The electronic apparatus of claim 6, wherein the outer wall comprises a base portion and a protrusion portion, the through hole is formed on the protrusion portion of the outer wall, and the protrusion portion protrudes from the base portion outwardly to form an accommodating space.

8. The electronic apparatus of claim 7, wherein the casing further comprises a plurality of position bosses protruding from the base of the outer wall toward the accommodating space to stop the keycap from moving outside the accommodating space.

9. The electronic apparatus of claim 7, wherein the casing further comprises a plurality of position bosses protruding from the protrusion portion of the outer wall toward the accommodating space to stop the keycap from moving outside the accommodating space.

10. The electronic apparatus of claim 6, wherein the resilient member further comprises a plurality of resilient arms, each of the resilient arms protrudes from one of the at least one fixed portion, and each of the resilient ends is formed on one of the resilient arms.

11. The electronic apparatus of claim 6, wherein a plurality of guiding grooves are formed on the engagement portion, and each of the resilient ends is slidablly disposed in one of the guiding grooves.
